(19) United States
(12) Patent Application Publication
(10) Pub. No.: US 2005/0187853 A1
(43) Pub. Date: Aug. 25, 2005

(54) Record company project management system

(76) Inventor: Bryan Calhoun, Atlanta, GA (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/063,104

(22) Filed: Feb. 22, 2005

Related U.S. Application Data
(60) Provisional application No. 60/546,446, filed on Feb. 20, 2004.

(51) Int. Cl. G06F 17/60; G11B 20/10

(52) U.S. Cl. 705/36; 705/28; 705/35

(57) ABSTRACT

A method of storing, manipulating, and retrieving comprehensive financial data specific to a music project, said method including inputting general information and financial information specific to said music project specific to expense estimates, revenue estimates, actual expenses, actual revenue, contractual information, inventory, and financial statements, organizing said general information and said financial information to allow retrieval of said information, selecting specific information from said general information and said financial information for review, generating data in response to said specific information selected, and displaying said specific information to allow a user to readily understand said specific information sought.

This application claims priority of Provisional Patent Application Ser. No. 60/546,446, filed on Feb. 20, 2004 wherein Feb. 20, 2005 was a Sunday and Feb. 21, 2005 was a Federal Holiday (President's Day).

### COPYRIGHT

A portion of the disclosure of this patent document contains material that is subject to copyright protection. The copyright owner has no objection to the xerographic reproduction by anyone of the patent document or the patent disclosure in exactly the form it appears in the Patent and Trademark Office patent file or records, but otherwise reserves all copyright rights whatsoever.

### BACKGROUND OF THE INVENTION

This invention relates to system management, and more particular to a method, system, online computer site and software program for providing a comprehensive financial model providing users an ability to detail estimated and actual expenditures and receipts at both an individual musical project level and a company level.

Estimating and calculating expenses involved with a record company developing new music projects is a complex process, especially for a small record company. Accurately tracking estimated costs as well as actual costs currently involves a plurality of software programs, where each program is not integrable with the next program. Because the software programs are not integrable, one problem that a record company faces is having to re-enter data across several programs or entering data produced by one program into another program. Errors can be made while entering this data.

Further, various users at a record company may have different needs and desires for presenting the data related to a specific music project. Some users may only need to access certain types of data, such as marketing and promotion estimates. Accordingly, there is a need in the art for improvements in managing financial aspects of music projects from inception through release. There is a continuing need in the art for a system that can access diverse data sources and display results in an organized and comprehensive manner according to user responsibility. The present invention is designed to address these needs.

### BRIEF DESCRIPTION OF THE INVENTION

The present invention solves the above-stated problems in the art by providing a system, method, software program and online computer site for displaying a comprehensive financial music project data using a single computer interface.

Features of the invention can be implemented in numerous ways, including as a system, a method, a computer site, or a computer readable medium (e.g., software program). The invention preferably relies on a communications infrastructure, for example the Internet, wherein individual interaction is possible. Several embodiments of the invention are discussed below.

The present invention comprises retrieving selected data for a specific phase of a music project. The present invention further comprises providing a customized graphical user interface to a user, wherein the graphical user interface displays a plurality of data elements arranged as a composite display, each of the data elements representative of the selected data retrieved.

A system for providing a display of a music project's data is also provided. As a computer system, part of the invention generally includes a database and a processor unit. The processor unit operates to run a computer code to present data desired by a user. Moreover, the output may include print or electronic media. The system comprises at least one database comprising data specific to the music project. The system further comprises a graphical user interface for displaying the data to a user. A computer code is also provided for retrieving selected data specific to a music project and customizing the graphical user interface for the user, wherein said graphical user interface displays data elements arranged as a display, each of the data elements representative of the selected data retrieved.

A computer program product, system, is also disclosed. The computer program product is recorded on computer readable medium and operational on a computer for providing a composite display of data for retrieving selected data for a music project and providing a customized graphical user interface to the user, wherein the graphical user interface displays data elements arranged as a display, each of the data elements representative of the selected network system management data retrieved. As a computer readable medium containing program instructions, an embodiment of the invention includes computer readable code devices for interacting with a user as noted above, processing that data, and generating printed or electronic media for that user.

Part or all of the data can also be sent electronically and maintained on a web server for confidential access with typical browsers. The data may also be transmitted and viewed by other well-known techniques such as email, interactive television, and the like. The computer site is preferably viewed with a client web browser through a web secure server communicating with an application server having a database associated therewith.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exemplary hardware environment used to implement a preferred embodiment of the invention;

FIG. 2 is high level diagram of an exemplary computing system network on which the present invention may be implemented;

FIG. 3 is a block diagram illustrating the association of multiple data sources into the composite display of the present invention;

FIG. 4 is an illustration of block diagrams representing an exemplary embodiment of the present invention;

FIGS. 5-7 are exemplary screen shots of the composite display/graphical user interface of the present invention; and

FIGS. 8-10 are exemplary screen shots of how data reports of the various data elements may be displayed.

It should be understood that in certain situations for reasons of computational efficiency or ease of maintenance, the ordering and relationships of the blocks of the illustrated flow charts could be rearranged or re-associated by one skilled in the art. While the present invention will be described with reference to the details of the embodiments of the invention shown in the drawings, these details are not intended to limit the scope of the invention.

### DETAILED DESCRIPTION OF THE INVENTION

Reference will now be made in detail to the embodiments consistent with the invention, examples of which are illustrated in the accompanying drawings. Wherever possible, the same reference numerals used throughout the drawings refer to the same or like parts.

The present invention solves the problems in the art by providing a system, method, and online computer site for providing a comprehensive financial model providing users an ability to detail estimated and actual expenditures and receipts at both an individual musical project level and a company level. Preferably, the invention is operated in conjunction with an interactive web site or stand alone software program.

The invention is primarily described as a method for providing a comprehensive financial model providing users an ability to detail estimated and actual expenditures and receipts at both an individual musical project level and a company level. However, persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the method of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

Broadly speaking, the invention provides a method, apparatus, and program for displaying comprehensive music project data dynamically matched and customized to a user's profile or function for efficient use of the data. To facilitate an understanding of the present invention, it is described hereinafter with reference to specific implementations thereof. The invention is described in the general context of computer-executable instructions, such as program modules, being executed by a computer. Generally, program modules include routines, programs, objects, components, data structures, etc. that perform particular tasks or implement particular abstract data types. For example, the software programs that underlie the invention can be coded in different languages, for use with different platforms. In the description that follows, examples of the invention are described in the context of a web portal that employs a web browser. It will be appreciated, however, that the principles that underlie the invention can be implemented with other types of computer software technologies as well.

Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Referring now to the drawings, embodiments of the present invention will be described. Generally speaking, the invention provides a customizable view of data and related information utilizing a composite data display model which filters and relates data based upon a desired type of information or report sought about a music project. At the user interface level, in one exemplary embodiment the invention dynamically presents a plurality of windows as an interface referred to as a “web portal” representing data from disparate sources that are represented in a composite layout.

The invention can be implemented in numerous ways, including as a system (including a computer processing system), a method (including a computerized method), an apparatus, a computer readable medium, a computer program product, a graphical user interface, including a web portal, or a data structure tangibly fixed in a computer readable memory. Several embodiments of the invention are discussed below.

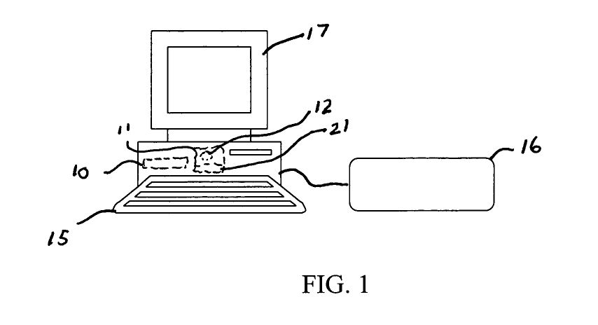

Referring to FIG. 1, as an example, a simple computing system, such as a personal computer, environment/network in which the present invention may be implemented is shown. The present invention may include at least one processor 10, a memory 11 coupled to the processor 10, and a program 12 residing in the memory 11 which implements the methods of the present invention as described herein. Information is contained in a database 21 that is accessible by the program 12. The present invention further may include a user input device 15 and a data output device 16, such as but not limited to a printer, to allow a user retrieve paper copies of reports or removable electronic media containing reports and/or data, and a display 17.

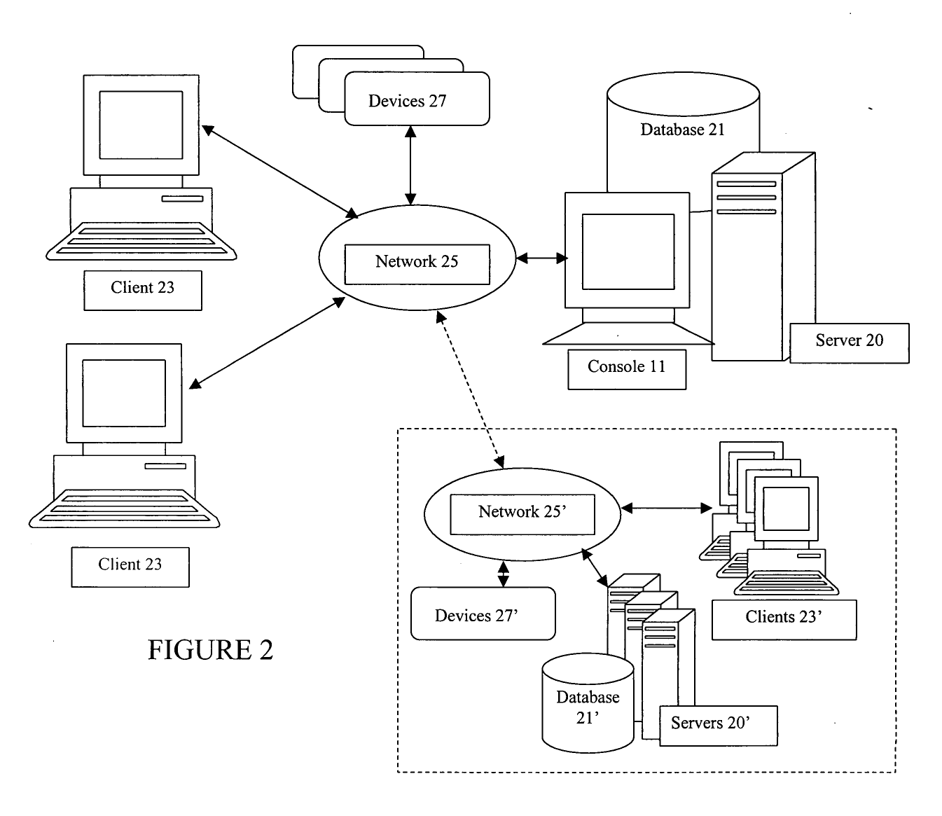

In another exemplary embodiment, illustrated in FIG. 2, a computing system includes at least one server 20 including a database 21, and a plurality of client computers 23 capable of accessing the applications on server 20 through a network 25. Additional devices 27 (e.g., router, switch, hub) are also connected on the network 25. The server 20 may be any of a number of known computers, or network of computers. Similarly, the client computer 23 may be any of a number of known computers, or network of computers 20′, 21′, 23′, 25′, 27′ capable of supporting a web browser such as Microsoft Internet Explorer or Netscape Navigator.

One of the more significant developments in the consumer industry in the last few years has been the embracing of the Internet by consumers in all aspects of their lives, from research to purchasing. With the Internet, a consumer, equipped with an appropriately connected computer and a browser, can explore vast amounts of information stored on computers around the world. Navigating (surfing) the Internet/Web is relatively simple, typically requiring only clicking a computer mouse to move between Web documents, even when the documents are located at separate locations.

HTML (Hypertext Markup Language) is one of the languages used to provide information on the Web. HTML provides a rich lexicon and syntax for designing and creating useful hypertext and hypermedia documents. With HTML, Web designers can describe the format and content of a Web document, which may include, for example, text filed, graphics files, and multimedia files. When accessed by a client computer (i.e., the computer local to the browser), the HTML file is transmitted to the client computer over a network such as the Internet and interpreted by the browser.

Users typically interact with computers and pages on the Internet with Graphical User Interfaces (GUIs). A conventional GUI display includes a desktop metaphor upon which one or more icons, application windows, or other graphical objects are displayed. Typically, a data processing system user interacts with a GUI display utilizing a graphical pointer, which the user controls with a graphical pointing device, such as a mouse, trackball, or joystick. For example, depending upon the actions allowed by the active application or operating system software, the user can select icons or other graphical objects within the GUI display by positioning the graphical pointer over the graphical object and depressing a button associated with the graphical pointing device. In addition, the user can typically relocate icons, application windows, and other graphical objects on the desktop utilizing the well-known drag-and-drop techniques. By manipulating the graphical objects within the GUI display, the user can control the underlying hardware devices and software objects represented by the graphical objects in a graphical and intuitive manner.

A number of software platforms have been developed for multimedia graphical user interfaces for the Web. For example, Macromedia Flash® is a multimedia interface that lets designers and developers integrate video, text, audio, and graphics into effective experiences. Web designers use Flash® to create beautiful, resizable, and extremely compact navigation interfaces, technical illustrations, long-form animations, and other dazzling effects. Graphics and animation will scale based on the viewer's screen size, providing high-quality viewing. The present invention generally comprises a multimedia interface for accessing the software application or website to use the present invention.

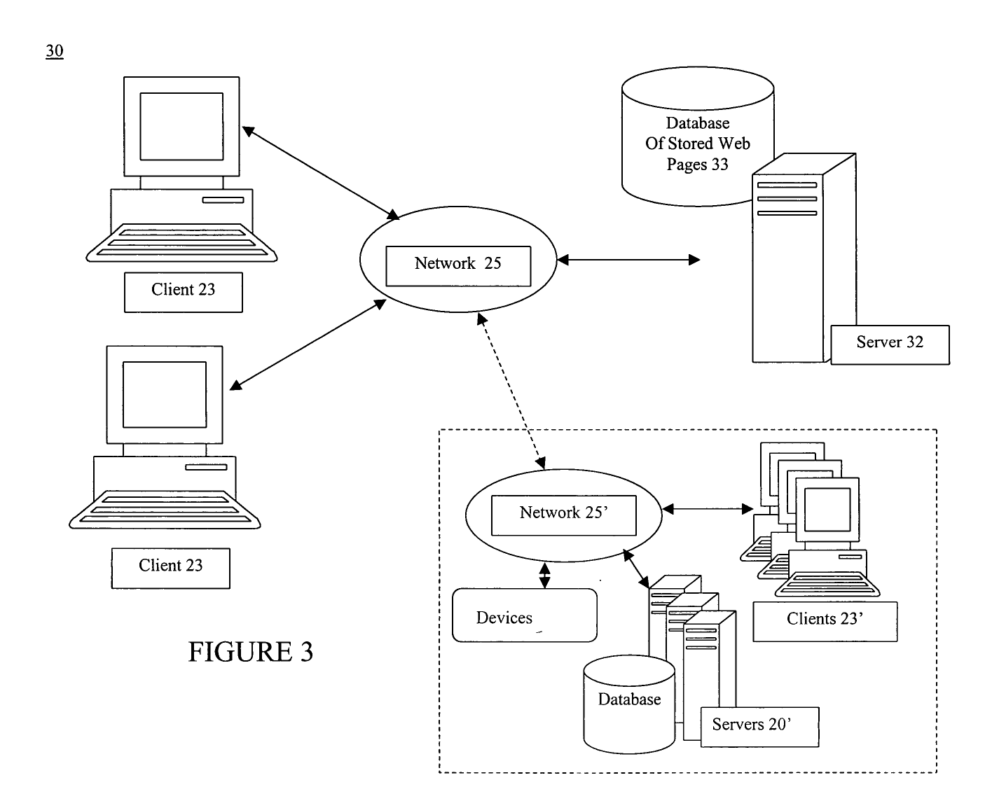

FIG. 3 is a high level diagram of an exemplary computing system network on which the present invention may be implemented. The system 30 includes a web server 32 for storing web pages 33, and a client computer 23 capable of accessing the web pages on server 32. The server 32 may be any number of known computers, or network of computers, capable of hosting a website. Similarly, the client 23 may be any number of known computers, or network of computers, capable of supporting a web browser. The server 32 and the client 23 are coupled to one another via a network 25, such as the Internet. To retrieve a web page stored on the server 32, the user of the client 23 specifies a URL (uniform resource locator). The specified URL allows web-browsing software running on the client 23 to initiate communication with the server 32 and access the desired HTML page, which a browser interprets and displays on the client 23.

As previously discussed, to view a web page on client 23, the user specifies, via a URL, the location of the desired web page. The browser on client 23 then retrieves the HTML file for the specified web page, interprets the file, and displays it as a web page.

In a preferred embodiment, the present invention operates similar to standard interactive web sites with the exception of having the additional unique features of the invention. Preferably, the invention is operated as an interactive multimedia website to provide the different features of the invention.

The client computers 23 are preferably complete, stand-alone, personal computers offering a full range of power and features to run applications. The client computer preferably operates under any operating system and includes communication devices, input devices, storage devices, and display devices. The user enters input commands into the computer processor through input devices that could comprise a keyboard, mouse, or the like. Alternatively, the input device could comprise any device used to transfer information or commands. The display comprises a computer monitor, television, LCD, LED, or any other means to convey information to the user. In a preferred embodiment, the user interface is a graphical user interface (GUI) in the form of a “web portal” written for web browser applications. The server computer(s) can be a personal computer, a minicomputer, or a mainframe and offer data management (information sharing between clients), network administration, security, web services, and other functions.

The present invention also envisions other computing arrangements for the client/server components, including processing on a single machine or other suitable means. Although many other internal components of the client/server components are not shown, those of ordinary skill in the art will appreciate that such components and the interconnection are well known. Accordingly, additional details concerning the internal construction of the client/server components and networking need not be disclosed in connection with the present invention.

The invention accesses a database 21, or a spreadsheet, to retrieve data. The database 21 or spreadsheet may reside on a user's computer, the server computer 20 or may reside on a separate computer in communication with the server computer via a network such as the Internet. Likewise, the database may reside on media such as a CD-ROM accessible using a CD-ROM drive associated with the user computer or server computer. The database contains at least one table having fields corresponding to the individual items of identifying information sought related to an aspect of developing a music project. Additional tables may be included to assist in managing the collected information. As will be understood by those skilled in the art, the search service receives requests for data from the server computer or user computer and conducts a search of corresponding data among the database.

The invention may also include a graphical user interface for presenting network system management data for one or more monitored devices interconnected on a network, comprising a plurality of data elements arranged in a single composite view, each data element representing a different representation of data sought for one or more monitored devices, wherein the monitored devices presented in the composite view are selectively filtered to include only those monitored devices associated with a specific music project.

Accordingly, the present invention solution allows for the association and presentation of key music project data elements into a single composite data display. It presents data elements which, when viewed in total, empower the end user to make better-informed management decisions regarding developing the project. By providing the composite display, the presentation and availability of these key data elements would be simplified, improving the likelihood that the collected data would be examined and used.

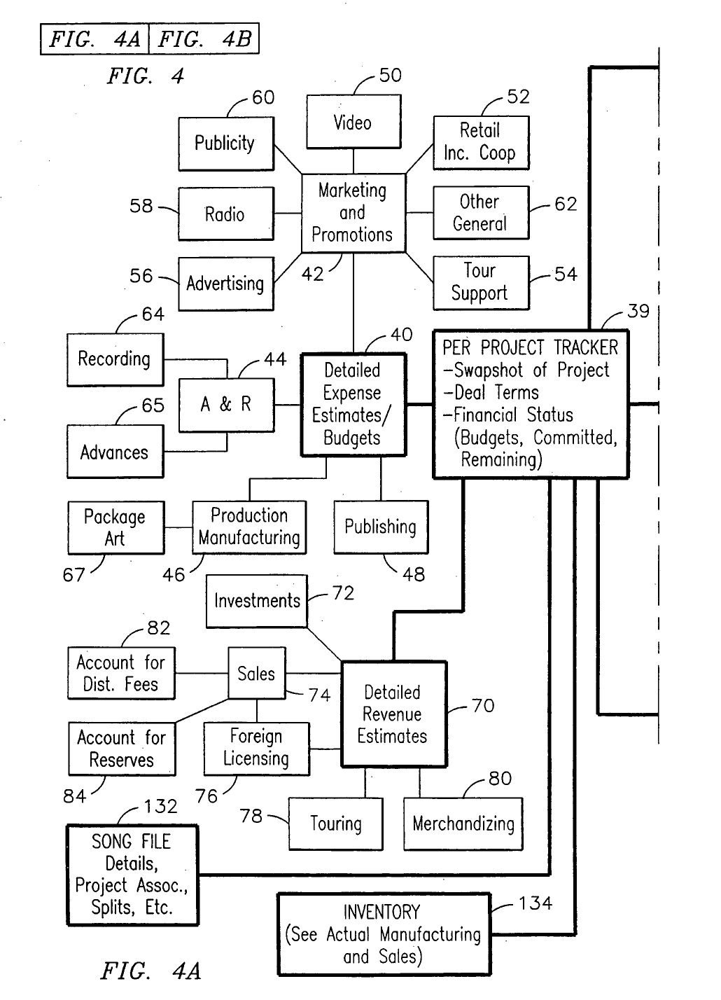

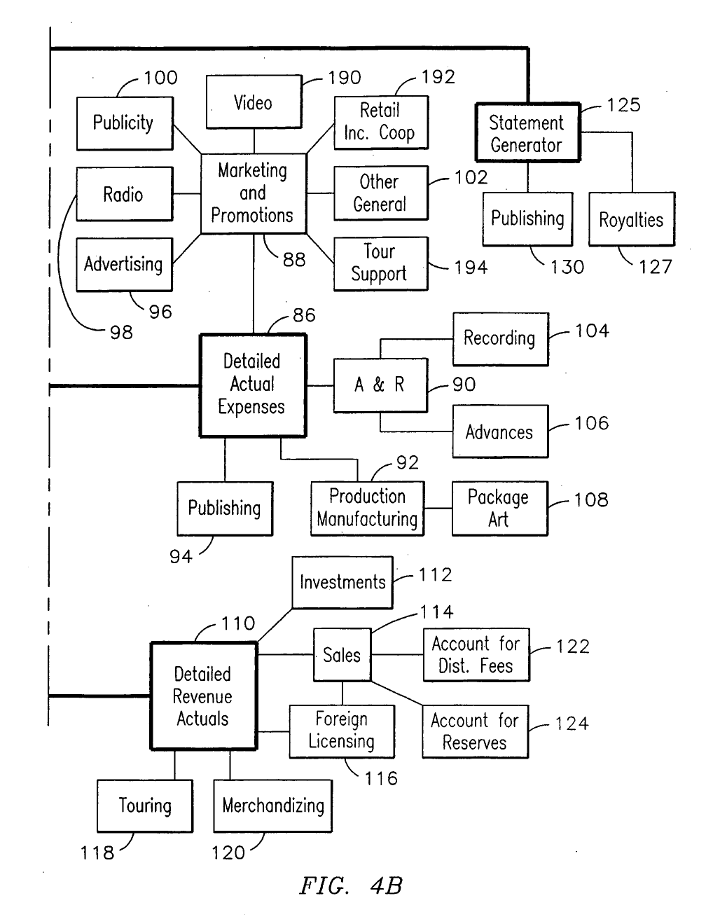

FIG. 4 is an illustration of the association of various aspects of a music project that require multiple data sources which may be displayed. The present invention is able to provide information on either a single project or a plurality of projects at the same time. In other exemplary embodiments, it is also able to provide information based on other categories, such as all music projects worked on by a specific artist, and/or producer, and/or songwriter, etc. Using the input device(s) 15, a user can input variables pertaining to a contractual agreement entered into by the record label and an artist, and/or a contractual agreement entered into by the record label and a distributor, a user can generate a report to project detailed financial information for individual projects. Reports can then be generated by a programmed processor to generate reports sought by the user.

Thus, as illustrated the present invention includes a plurality of modules that the user can use to obtain information, such as, but not limited to in a general sense, a snapshot of the music project, contractual terms, financial status including budgets, amounts committed, and amounts remaining. This information can pertain to either the complete project or aspects of the music project. The primary module is identified as the Per Project Tracker 39. A user can then select a plurality of other modules to determine the information that is sought.

As further illustrated in more detail, a Detailed Expense Estimates/Budgets module 40 is provided. The types of information that may be calculated/retrieved under this module include, but is not limited to sub-modules for Marketing and Promotion 42, Advances and Recording (hereinafter “A & R”) 44, Production/Manufacturing 46, and Publishing 48. Under the Marketing and Promotion sub-module 42, mini-modules to obtain information pertaining to such categories as Video 50, Retail including Co-op advertising 52, Tour Support 54, Advertising 56, Radio 58, Publicity 60, and Other General Matters 62 related to marketing and promotion are provided. Under the A & R sub-module 44, mini-modules to obtain information pertaining to such categories as Recording 64 and Advances 65 is provided. The Production/Manufacturing sub-module 46 includes information pertaining to Package Art 67.

Another module 70 provides information regarding Detailed Revenue Estimates where sub-modules for Investments 72, Sales 74, Foreign Licensing 76, Touring 78, and Merchandizing 80 are provided. The Sales sub-module 74 may be used to obtain information regarding Account for Distribution Fees 82, and Account for Reserves 84.

A Detailed Actual Expenses module 86 is also provided. The types of information that may be calculated/retrieved under this module include, but is not limited sub-modules for Marketing and Promotion 88, A & R 90, Production/Manufacturing 92 and Publishing 94. Under the Marketing and Promotion sub-module 88, mini-modules to access information pertaining to such categories as Video 190, Retail Including Co-op Advertising 192, Tour Support 194, Advertising 96, Radio 98, Publicity 100, and Other General Matters 102 related to marketing and promotion are provided. Under the A & R sub-module 90, mini-modules to access information pertaining to such categories as Recording 104 and Advances 106 is provided. The Production/Manufacturing sub-module 92 includes information pertaining to Package Art 108.

A Detailed Revenue Actuals module 110 is further provided where sub-modules for Investments 112, Sales 114, Foreign Licensing 116, Touring 118, and Merchandizing 120 are also provided. The Sales sub-module 114 may be used to obtain information through mini-modules regarding Account for Distribution Fees 122 and Account for Reserves 124.

Other modules available may include a Statement Generator module 125 with sub-modules of Royalties 127 and Publishing 130, a Song File module 132 with sub-modules for information pertaining to details about the music project, negotiated financial splits, individuals associated with the project, etc., and an Inventory module 134 with information regarding actual manufacturing and sales data.

Thus when a specific module is used, the system can provide various sorts of reports, such as but limited to detailed expense estimates/budget data, inventory listing data, detailed revenue estimate data, information about song file data, detailed actual expense data, detailed revenue actual data, and generated funding data where each general report category can be further viewed in the exemplary subsets as discussed above.

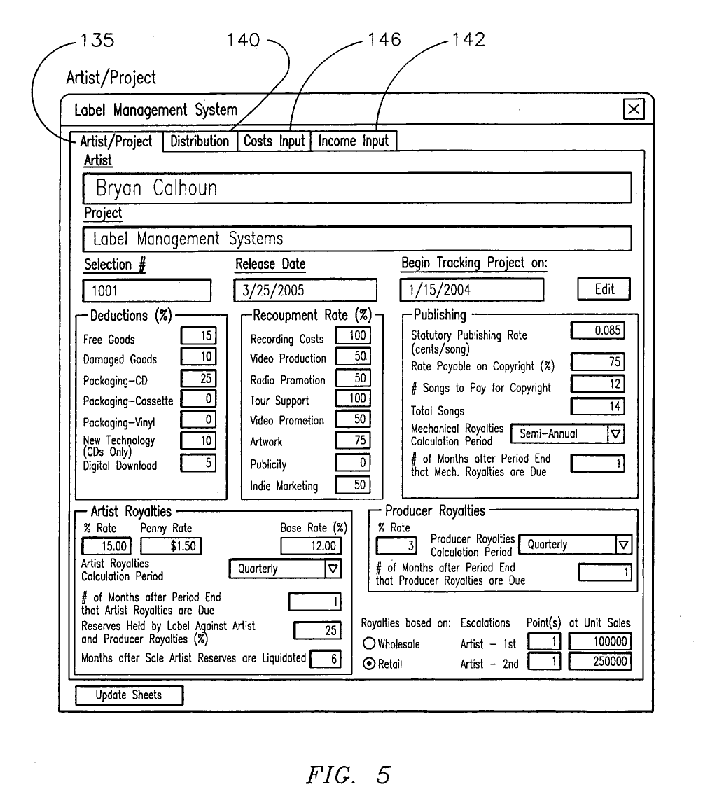

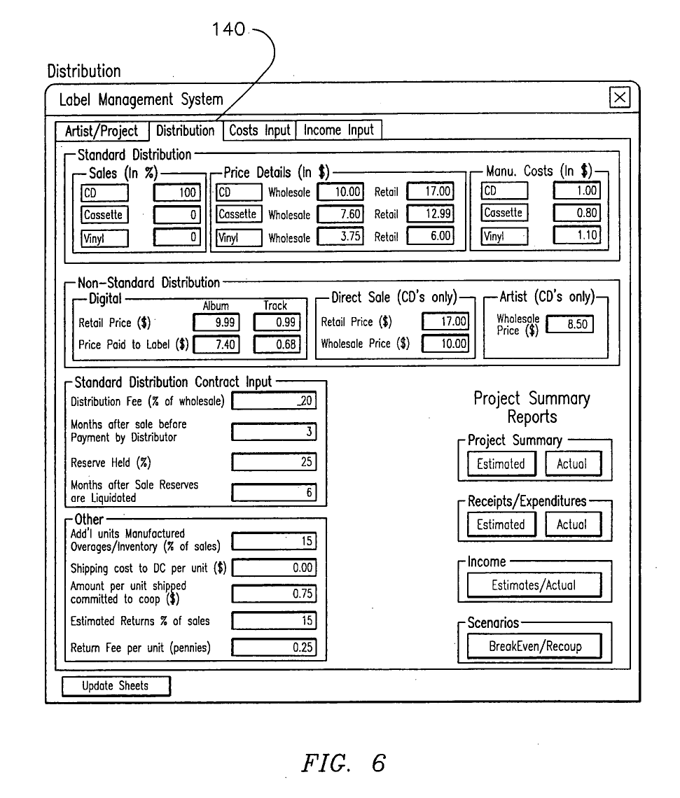

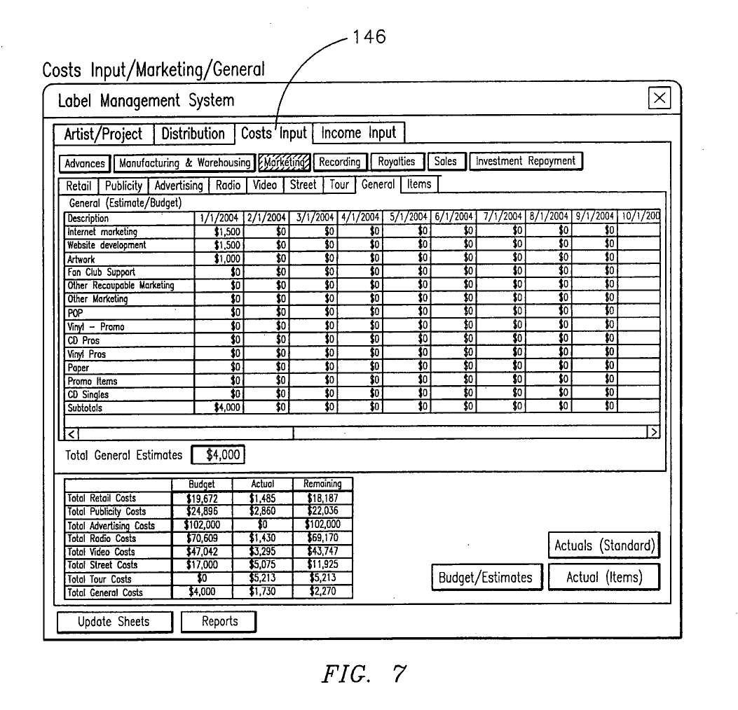

FIGS. 5-7 are exemplary screen shots of composite display/graphical user interface of the present invention. As illustrated in FIG. 5, a screen where the user can input data specific to the Artist/Project, Distribution, Cost Input, and income Input is illustrated. FIG. 5 illustrates exemplary fields available under the Artist/Project heading whereas FIG. 6 illustrates exemplary fields available under the Distribution heading. FIG. 7 illustrates exemplary fields available under the Cost Input field wherein additional categories, such as Marketing are available. A user can enter data on these screens wherein the program residing in the processor can then apply that entered data against stored data and provide estimates and/or actual expenses or revenue, and/or information specific to any of the other modules.

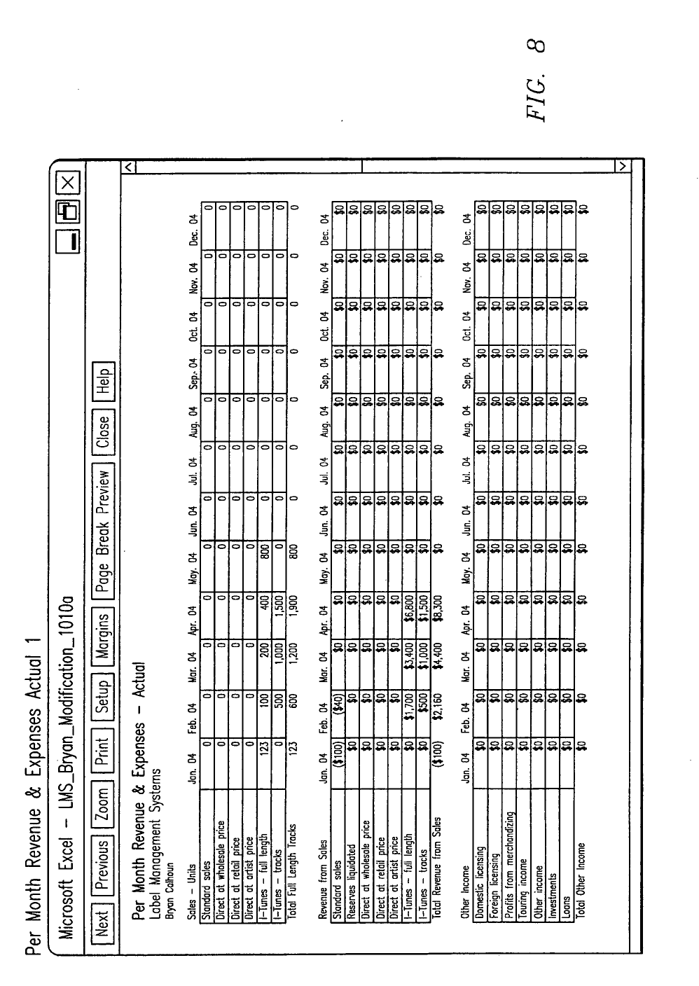

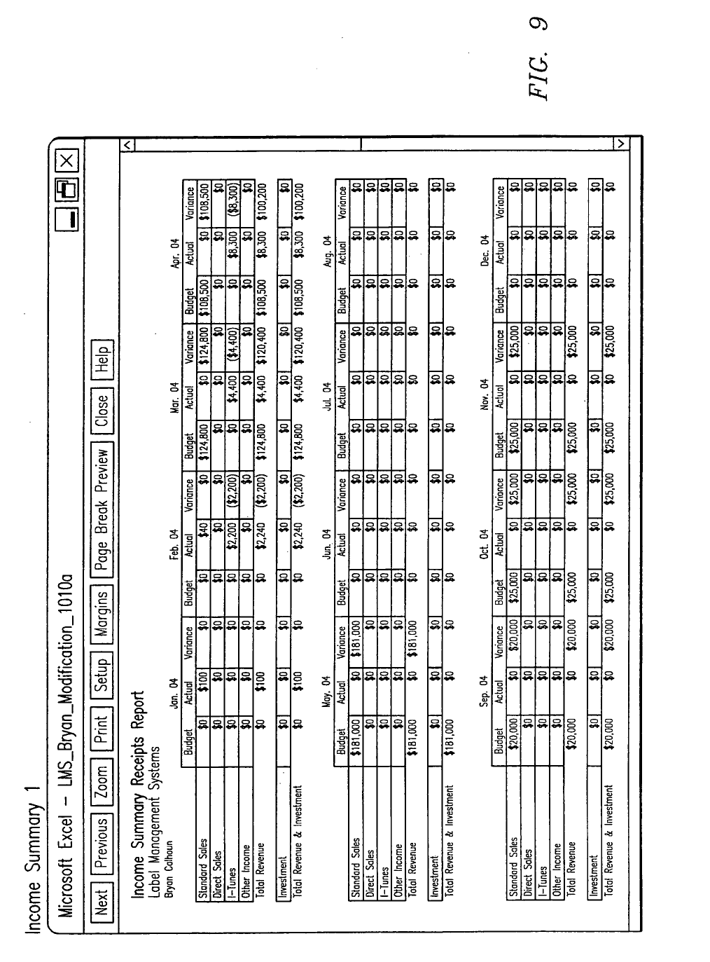

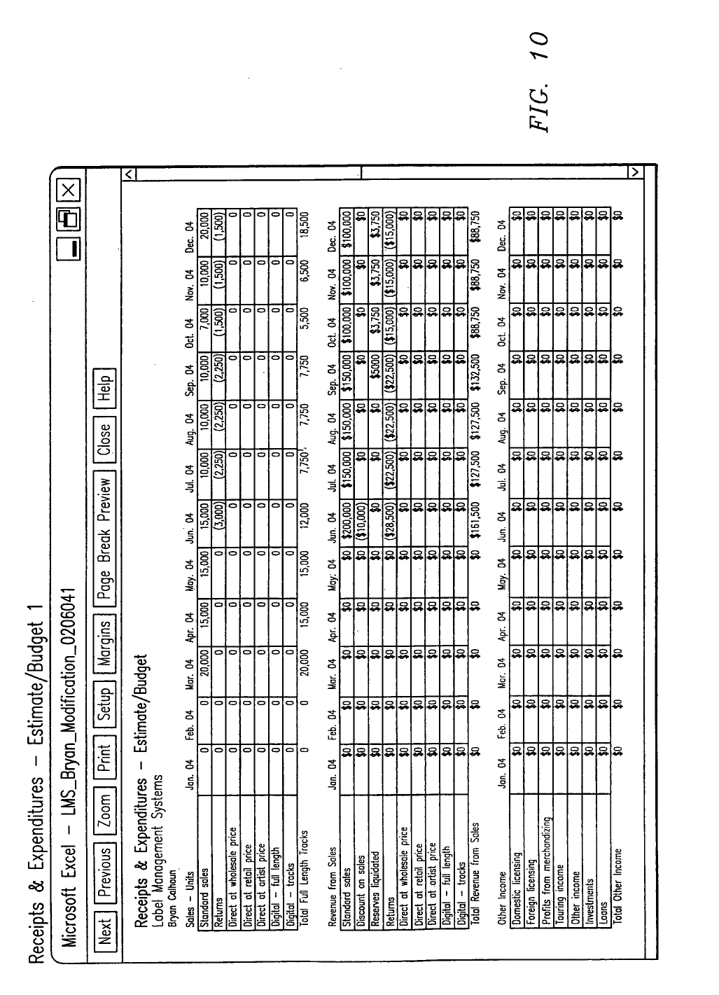

FIGS. 8-10 illustrate exemplary data reports of a limited number of the various data elements discussed above. These reports can be printed or saved and delivered to another user either electronically or stored on a removable media. The figures illustrate data reports for per month revenue and expenses, FIG. 8, income summary, FIG. 9, and receipts and expenditures based on an estimate/budget, FIG. 10.

This in operation, aggregated data is maintained, displayed and organized in a composite view. In a display interface, the end user can view expense estimates, revenue estimates, specific information about a music project, inventory, detailed expenses, generated money, and detailed revenue, without switching between a plurality of programs or having to transfer data from one program to another to view the data in a format desired by the end user. Towards this end, the invention relates, arranges, and displays data. It is not a data collector but a data consumer and presentation tool for the aforementioned solutions.

Though the invention is disclosed as though a single and/or individual project is being reviewed at a time, those skilled in the art will readily recognize that a plurality of projects can be viewed and/or reports generated at the same time. Furthermore, those skilled in the art will fully understand and comprehend the terms and information in the present invention as know how it is to be used in the music industry.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

1. A method of storing, manipulating, and retrieving comprehensive financial data specific to a music project, said method comprising:
a) inputting general information and financial information specific to said music project specific to expense estimates, revenue estimates, actual expenses, actual revenue, contractual information, inventory, and financial statements;
b) organizing said general information and said financial information to allow retrieval of said information;
c) selecting specific information from said general information and said financial information for review;
d) generating data in response to said specific information selected; and
e) displaying said specific information to allow a user to readily understand said specific information sought.

2. The method of claim 1 further comprising electronically delivering said specific information for at least one of storage and viewing in a different medium.

3. The method of claim 1 wherein said general information and said financial information comprises at least one of expense estimates, revenue estimates, actual expenses, actual revenue, and information specific to contractual requirements.

4. A computer-based system for at least one of storing, manipulating, and retrieving comprehensive financial data specific to a music project, said system comprising:
a) a first module for at least one of storing, manipulating and retrieving data specific to expense estimates;
b) a second module for at least one of storing, manipulating and retrieving data specific to revenue estimates;
c) a third module for at least one of storing, manipulating and retrieving data specific to a song file;
d) a fourth module for at least one of storing, manipulating and retrieving data specific to inventory related to said music project;
e) a fifth module for at least one of storing, manipulating and retrieving data specific to generating states regarding at lest one of royalties and publishing deals;
f) a sixth module for at least one of storing, manipulating and retrieving data specific to actual expenses; and
g) a seventh module for at least one of storing, manipulating and retrieving data specific to actual revenue.

5. The system of claim 4 wherein said first module, said second module, said third module, said fourth module, said fifth module, said sixth module, and said seventh module can be combined and expanded to create any number of modules.

6. The system of claim 4 wherein said first module and said sixth module further comprises segments for at least one of marketing and promotions, advances and recording, production and manufacturing, and publishing.

7. The system of claim 6 wherein said segment for marketing and promotions further comprises segments for at least one of video, publicity, radio, advertising, retail in co-op, tour support and other general matters specific to marketing and promotions.

8. The system of claim 6 wherein said segment for Advances and Recording further comprises segments for at least one of advances, and recording.

9. The system of claim 6 wherein said segment for Production and Manufacturing further comprises a segment for package art.

10. The system of claim 4 wherein said second module and said seventh module further comprises segments for at least one of investments, sales, foreign licensing, touring and merchandising.

11. The system of claim 10 wherein said segment for sales further comprises segments for distribution fee accounts and reserves accounts.

12. The system of claim 4 wherein financial data specific to a plurality of music projects can be at least two of stored, manipulated, and retrieved at a same time.

13. The system of claim 4 wherein said system is recorded on computer readable medium.

14. The system of claim 4 wherein said system is operated over a computer network.

15. The system of claim 4 further comprising a graphical user interface wherein said graphical user interface displays a plurality of data elements arranged as a composite display, each of said data elements representative of selected data retrieved.

16. The system of claim 4 wherein a communications infrastructure is provided wherein individual interaction is possible.

17. A method for allowing a user to determine detail estimated and actual expenditures and receipts at both an individual music project level and a company level, said method comprising:
a) inputting information regarding detailed estimated and actual expenditures and receipts;
b) associating said information to an individual music project;
c) selecting a type of information for viewing;
d) generating data in response to said information selected; and
e) displaying said type of information selected.

18. The method of claim 17 wherein the steps of inputting information, associating said information, selecting a type of information, generating data, and displaying said type of information are performed simultaneously for a plurality of music projects.

19. The method of claim 17 further comprises at least one of inputting and eventually displaying contractual information specific to a music project, and inputting information specific to inventory information about said music project.
